(19) United States
(12) Patent Application Publication
(10) Pub. No.: US 2007/0278247 A1
(43) Pub. Date: Dec. 6, 2007

(54) Foam dispenser and method of making foam from more than one liquid

(76) Inventors: Stewart Banks, Algarve (PT); Shaun Kerry Matthews, Lincoln (GB)

Correspondence Address: Ralph A. Dowell of DOWELL & DOWELL P.C., 2111 Eisenhower Ave, Suite 406, Alexandria, VA, 22314, US

(21) Appl. No.: 11/442,603

(22) Filed: May 30, 2006

(51) Int. Cl. B67D 5/60

(52) U.S. Cl. 222/132; 222/190; 222/145.6; 222/137

(57) ABSTRACT

A foam dispenser for dispensing foam from a first and a second liquid includes a first and a second liquid container for first and second liquids respectively. The dispenser includes a pumping mechanism for pumping the first liquid, second liquid and gas. The dispenser also includes a first foaming mechanism for forming a first foam. It is in flow communication with the first liquid container and a gas inlet and it includes a first mixing zone. A second mixing zone is in flow communication with the second liquid container and the first foaming mechanism wherein the first foam is mixed with the second liquid to form a final foam.

### FIELD OF THE INVENTION

This invention relates to dispensers and in particular to foam dispensers wherein the foam dispensed is made from at least two liquids and wherein one of the liquids may have particles suspended therein.

### BACKGROUND OF THE INVENTION

Liquid dispensers for dispensing soap and the like are well known. There are a wide variety of liquid dispensers for use in association with liquid soap. Some of these dispense the soap or other liquid in the form of foam. There are a number of advantages that are realized by dispensing in the form of foam. Specifically foam is easier to spread than the corresponding liquid. As well there is much less splashing or run-off since the foam has a much higher surface tension than the liquid. In addition, the foam requires much less liquid to produce the same cleansing power as compared to the un-foamed liquid due to the much higher surface area of the foam. Accordingly the cost to wash a specific number of hands is reduced since the amount of soap used is reduced. Similarly there are environmental benefits from using the foam since the amount of product used is reduced.

In general, foam dispensed from non-aerosol dispensers is generated by passing an air and liquid mixture through a porous member. Accordingly, if the air and liquid mixture includes particles the particles would not pass through the porous member and overtime the porous member would become clogged and unusable. Typically the prior art foam dispensers use a single source of liquid that is mixed with air to form foam. Since only one liquid is used that the properties of that liquid are restricted to liquids that will foam. Accordingly, a non-aerosol dispenser that can produce a foam from one liquid and then mix the foam with a second liquid would be desirable. Such a dispenser would allow the user to produce foam with a variety of different properties. For example foam with particles therein could be produced from a foaming liquid and a second liquid with particles therein. Further foam could be produced from a foaming liquid and a second liquid wherein the second liquid has particular properties such as that it when mixed with the foam produces an exothermic reaction.

### SUMMARY OF THE INVENTION

The present invention is a foam dispenser for dispensing foam from a first and a second liquid and it includes first and second liquid containers for first and second liquids respectively. The dispenser is provided with a pumping mechanism for pumping the first liquid, second liquid and gas. The dispenser also includes a first foaming mechanism for forming a first foam. It is in flow communication with the first liquid container and a gas inlet and it includes a first mixing zone. A second mixing zone is in flow communication with the second liquid container and the first foaming mechanism wherein the first foam is mixed with the second liquid to form a final foam.

In another aspect of the invention there is disclosed a method of making foam comprising the steps of: forming a first foam from a first liquid and gas; mixing a second liquid with the first foam to form a final foam.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a cross sectional view of a first embodiment of the foam dispenser of the present invention;

FIG. 2 is an enlarged cross sectional view of the foaming component of the foam dispenser of FIG. 1;

FIG. 3 is a cross sectional view of a second embodiment of the foam dispenser of the present invention;

FIG. 4 is an enlarged cross sectional view of the foaming and mixing portion of the foam dispenser of FIG. 3;

FIG. 5 is an enlarged cross sectional view of the foaming and mixing portion of the foam dispenser similar to that of FIG. 4 but showing a turbulent mixing zone;

FIG. 6 is an enlarged partially broken away perspective view of the foaming and mixing portion of FIG. 5;

FIG. 7 is an enlarged cross sectional view similar to that of FIG. 4 but showing a static mixing zone;

FIG. 8 is an enlarged partially broken away sectional view of the static mixing zone of FIG. 7;

FIG. 9 is a cross sectional view of a third embodiment of the foam dispenser of the present invention similar to that shown in FIG. 1 but showing inverted liquid containers;

FIG. 10 is a cross sectional view of a fourth embodiment of the foam dispenser of the present invention similar to that shown in FIG. 9 but showing an air intake through the nozzle;

FIG. 11 is a cross sectional view of an alternate foam dispenser similar to that shown in FIG. 10 but showing a second mixing zone downstream of the exit nozzle;

FIG. 12 is an end view of the exit nozzle of FIG. 11;

FIG. 13 is a cross sectional view of an alternate foam dispenser similar to FIG. 11 and showing a second mixing zone downstream of an alternate exit nozzle;

FIG. 14 is an end view of the exit nozzle of FIG. 13.

FIG. 15 is a cross sectional view of another alternate foam dispenser similar to that shown in FIGS. 11 and 13 and showing a second mixing zone downstream of another alternate exit nozzle; and

FIG. 16 is an end view of the exit nozzle of FIG. 15.

### DETAILED DESCRIPTION OF THE INVENTION

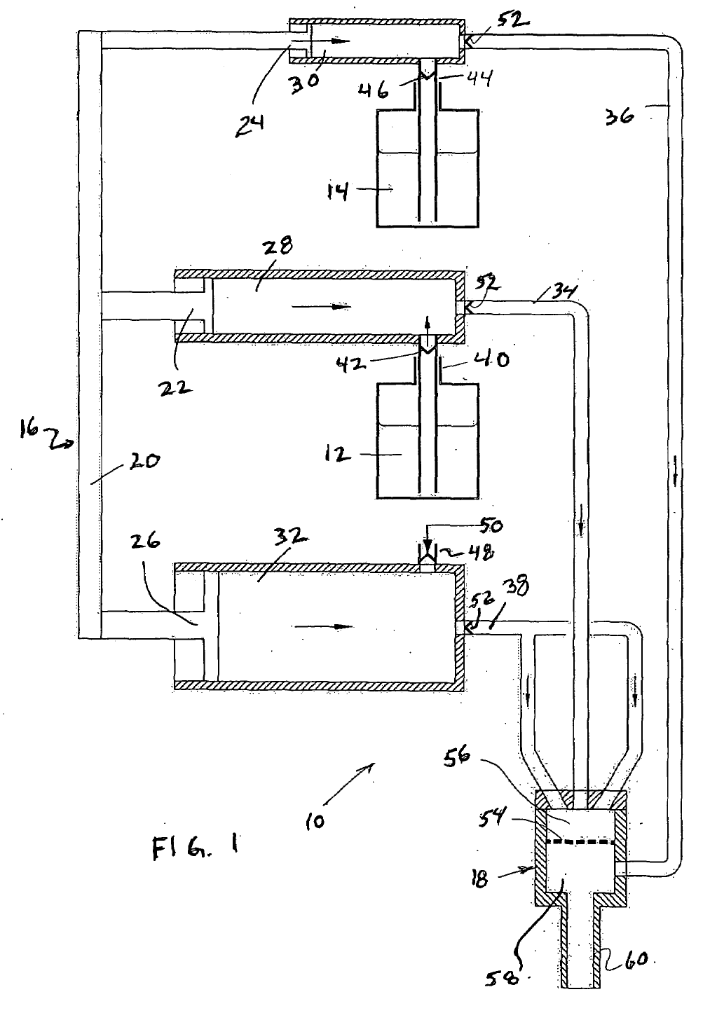

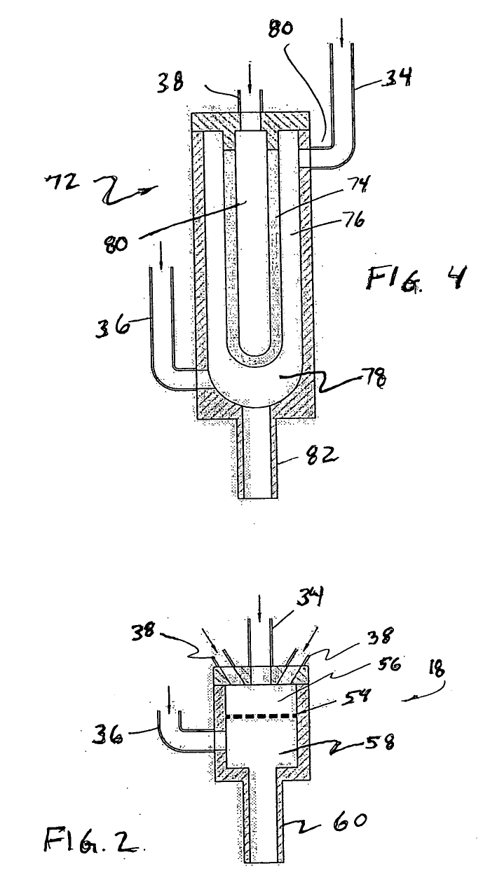

Referring to FIGS. 1 and 2, the foam dispenser of the present invention is shown generally at 10. Dispenser 10 includes a first liquid container 12, a second liquid container 14, a pump mechanism 16 and a foaming component 18. The second liquid container contains a liquid having specific properties. For example the second liquid may contain particles suspended therein. Alternatively, the second liquid contains a liquid with specific properties such as when it is mixed with the first liquid it produces an exothermic reaction. However, the dispenser and method described herein could be used with any two different liquids where the first liquid is initially foamed. It will be appreciated by those skilled in the art that for most application the liquid will be mixed with air to produce foam. However, there may be applications where other gases may be preferable to air and the use of such gases is encompassed by this application.

The pump mechanism 16 includes a drive bar 20 with a first liquid piston 22, a second liquid piston 24 and a gas piston 26. The first liquid piston 22 moves in the first liquid chamber 28, the second liquid piston 24 moves in a second liquid chamber 30 and the gas piston 26 moves in the air or gas chamber 32. The first liquid chamber 28, second liquid chamber 30 and the gas chamber 32 are connected by first liquid conduit 34, second liquid conduit 36, and gas conduit 38 respectively to the foaming component 18. Each chamber 28, 30, 32 has an interior volume that is changeable responsive to the movement of the respective piston 22, 24, 26. The relative sizes of the liquid chamber 28, 30 and the gas chamber 32 are arranged to provide the air to soap ratio desired for the resultant foam.

First liquid container 12 is in flow communication with a first liquid chamber 28 through inlet 40. A non-return valve 42 is positioned therein. Second liquid container 14 is in flow communication with the second liquid chamber 30 through inlet 44. A non-return valve 46 is positioned therein. The gas chamber 32 has a gas inlet 48. Non-return valve 50 is positioned in gas inlet 48. Conduit non-return valves 52 are positioned in the first liquid conduit 34, second liquid conduit 36 and gas conduit 38 preferably proximate to the respective liquid or gas chamber.

The foaming component 18 includes a porous member 54 which divides the foaming component 18 into a first mixing zone 56 and a second mixing zone 58. The porous member 54 may be made from a number of different materials such as wire gauze, grid or mesh. The first liquid conduit 34 is in flow communication with the first mixing zone 56 upstream of the porous member 54. Similarly the gas conduit 38 is in flow communication with the first mixing zone 56 upstream of the porous member 54. Preferably the gas conduit 38 bifurcates before it feeds into the first mixing zone 56. The second liquid conduit 36 is in flow communication with the second mixing zone 58.

In the first mixing zone 56 gas from the gas chamber 32 is mixed with liquid from the first liquid chamber 28. The mixture of gas and liquid is then pushed through the porous member 54 to produce foam. The foam is then mixed with liquid from second liquid chamber 30 thereby adding the second constituent to the foam and producing a foam with different properties.

In use, a person causes the drive bar 20 to move inwardly. This causes the first liquid piston 22, the second liquid piston 24 and the gas piston 26 to reduce the interior volume of the first liquid chamber 28, second liquid chamber 30 and the gas chamber 32 respectively. The increase in pressure caused by moving pistons 22, 24 and 26 will open non-return valves 52 in the first liquid conduit 34, second liquid conduit 36 and gas conduit 38.respectively. Gas from the gas chamber 32 and liquid from the first liquid chamber 28 are pushed into the first mixing zone 56 where they are mixed. The gas and first liquid mixture is pushed through the porous member 54 to produce foam. Liquid from the second liquid chamber 30 is pushed into the second mixing zone 58 where it is mixed with the initial foam to produce the final foam which is dispensed through nozzle 60. When the drive bar 20 is released the drive bar moves back to the at rest position, causing a vacuum in the first liquid chamber 28, second liquid chamber 30 and the gas chamber 32 thus closing the valves 52 in the first and second liquid conduit 34, 36 and the gas conduit 38 and opening the valves 42, 46, 50 in the liquid inlets 40, 44 and the gas inlet 48 respectively. First and second liquids then flow into first and second liquid chambers 28, 30 and gas flows into the gas chamber 32. When equilibrium is reached the valves 42, 46, 50 will close. The dispenser is then ready to dispense the next shot of foam.

The first and second liquids are chosen such that a final foam having the desired properties is produced. It will be appreciated by those skilled in the art that by mixing a foam with a second liquid that may include particles, a foam having particles suspended therein may be produced by the device of the present invention. The ratios among the volumes of the first liquid chamber, the second liquid chamber and the gas chamber are chosen taking into account the application and the properties desired for the final foam. In the instance where the second liquid includes particles the ratio of the first liquid to the second liquid is in the range of 5:1 and 1:1. However, it will be appreciated by those skilled in the art that this method and device may be used where neither the first nor the second liquid has particles therein and the liquids are chosen for other properties and therefore the ratios may be quite different. The particles in the second liquid are chosen as desired. For example, the particles may be include pumice, cornmeal, ground walnut shells, ground fruit stones, microbeads (polyethylene, polypropylene etc.), microcapsules and dried pulses (peas etc.) or a combination thereof. The microcapsules could have a variety of different properties, for example when broken a fragrance is released, or they may contain a dye, or they may have an active constituent that is unstable such that when it is broken an exothermic reaction takes place and the foam will be a heated foam.

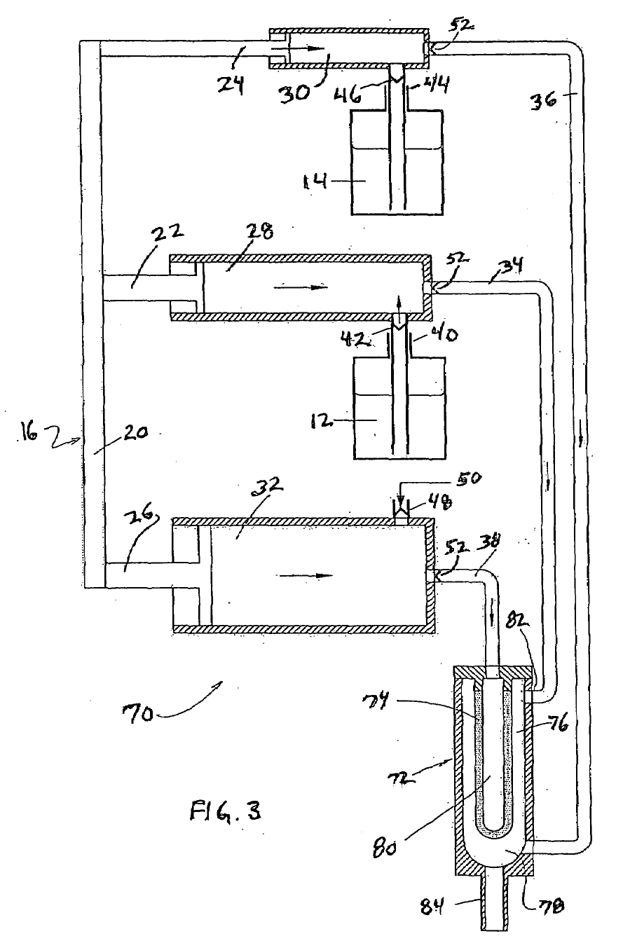

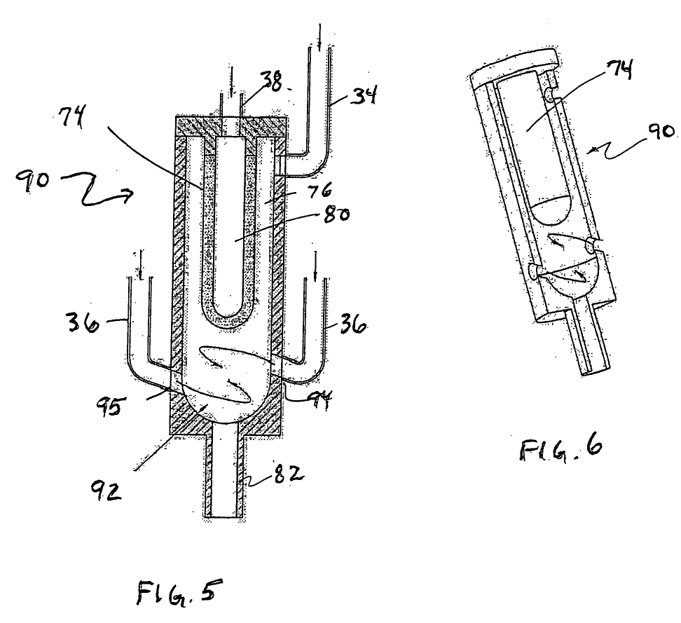

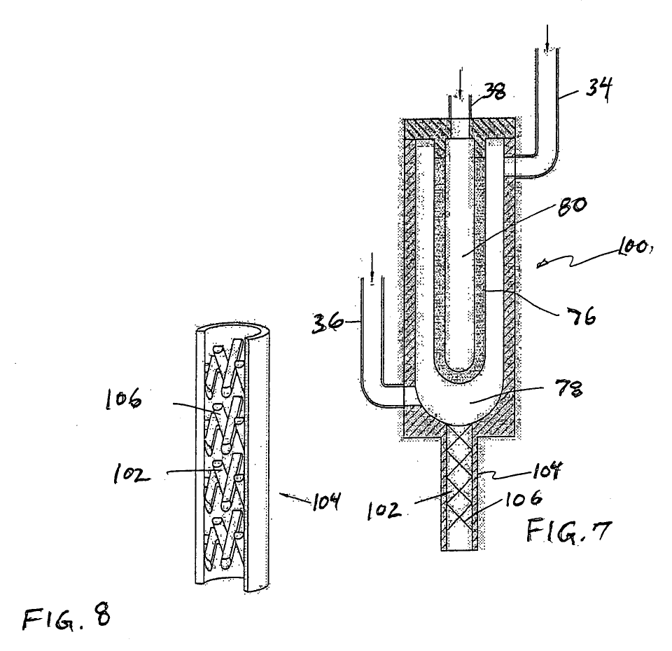

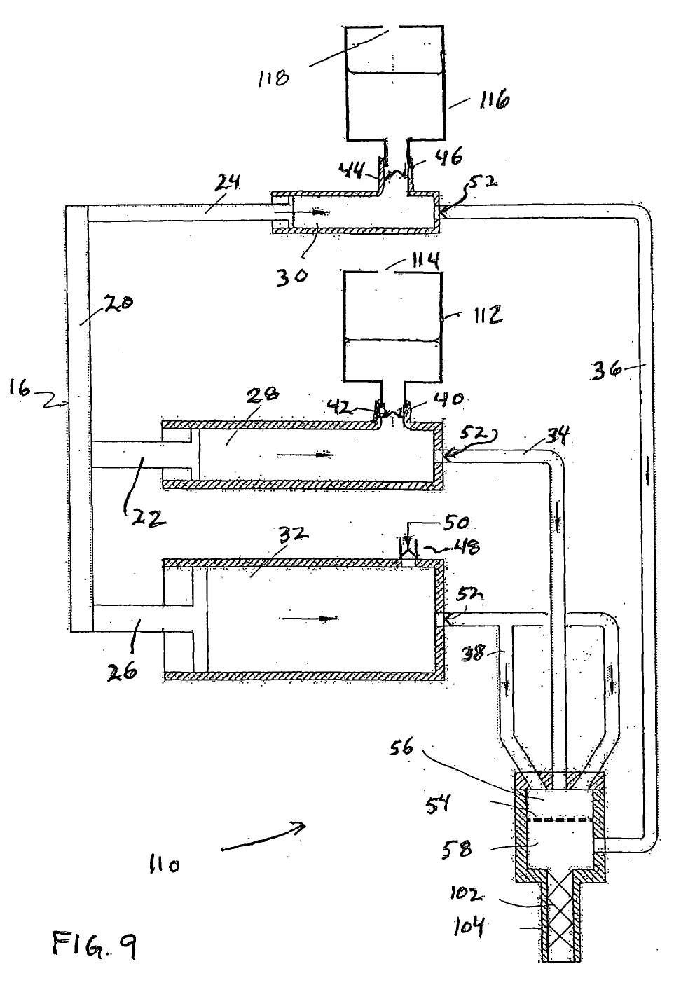

An alternate embodiment of the dispenser and foaming component of the present invention is shown at 70 and 72 respectively in FIGS. 3 and 4. Dispenser 70 is similar to that shown in FIG. 1 except for the foaming component 72 herein. Accordingly, only the foaming component will be described in detail in regard to dispenser 70 because the other elements are as described above.

The foaming component 72 includes a porous mandrel 74 and a first mixing zone 76 and a second mixing zone 78. Second mixing zone 78 is down stream of first mixing zone 76. The interior of the porous mandrel 74 defines a gas chamber 80. The porous mandrel is in the centre of the foaming component 72 and is generally a test tube shape. The first mixing zone 76 is an annular chamber around the porous mandrel 74. The first mixing zone 76 generally follows the shape of the porous mandrel 74 and is generally an elongate annular tube. The porous mandrel 74 has an open end that is in flow communication with the gas conduit 38. The first liquid conduit 34 is in flow communication with the first mixing zone 76 through an inlet 82. Inlet 82 is positioned as upstream as practicable in the foaming component 72. The second liquid conduit 36 is in flow communication with the second mixing zone 78. The foaming component has an exit nozzle or outlet 84.

Referring to FIGS. 5 and 6, a foaming component similar to that shown in FIG. 4 but wherein the second mixing zone is a turbulent mixing zone is shown generally at 90. The second mixing zone 92 shown herein includes a first and second inlet 94 and 95 respectively for the second liquid conduit 36, shown in FIG. 5. Second liquid conduit 36 would be bifurcated proximate to the foaming component 90. The two inlets 94 and 95 are offset and the angles of entrance are such that one of the inlets is angled downwardly and one inlet is angled upwardly. The remainder of the foaming component is described above in regard to FIGS. 3 and 4. Specifically foaming component 90 includes a porous mandrel 74 and a first mixing zone 76. The second mixing zone 92 is down stream of first mixing zone 76. The interior of the porous mandrel 74 defines a gas chamber 80. The positioning of the two inlets 94 and 95 serves to increase the turbulence in the second mixing zone 92 between the foam produced in the first mixing zone 76 and the first liquid. The second mixing zone 92 is somewhat larger than that shown in FIGS. 3 and 4.

Referring to FIGS. 7 and 8 an alternate foaming component is shown at 100. This embodiment is similar to foaming component 72 shown in FIGS. 3 and 4 but it includes a static mixing device 102 in the outlet or nozzle 104. The remainder of the foaming component is as described above and will not be described again. Static mixing device 102 includes a plurality of fingers 106 are positioned in the nozzle 104. The fingers are interleaved and adjacent fingers 106 are angled in opposite directions. The fingers 106 are generally arranged in a plurality of rows. The fingers 106 act as a static mixing device wherein the foam and second liquid are mixed. It will be appreciated by those skilled in the art that the static mixing device may be a wide variety of other devices and the interleaved fingers 106 were chosen by way of example only.

In use the dispenser shown in FIGS. 3 and 4, the variations of which are shown in FIGS. 5 through 8, functions very similarly to the dispenser shown in FIGS. 1 and 2. Specifically, a person causes the drive bar 20 to move inwardly. This causes the first liquid piston 22, the second liquid piston 24 and the gas piston 26 to reduce the interior volume of the first liquid chamber 28, second liquid chamber 30 and the gas chamber 32 respectively. The increase in pressure caused by moving pistons 22, 24 and 26 will open non-return valves 52 in the first liquid conduit 34, second liquid conduit 36 and gas conduit 38 respectively. Gas from the gas chamber 32 is pushed into the gas chamber 80 in the interior of the porous mandrel 74. Liquid from the first liquid chamber 28 is pushed into the first mixing zone 76 and gas is pushed from the gas chamber 80 through the porous mandrel 74 thereby pushing small bubbles into the first liquid to produce a first foam. Liquid from the second liquid chamber 30 is pushed into the second mixing zone 78 where it is mixed with the initial foam to produce the final foam which is dispensed through nozzle 84. In the embodiment shown in FIGS. 5 and 6 the second mixing zone 92 is a turbulent mixing zone and the embodiment shown in FIGS. 7 and 8 static mixing is achieved in the nozzle 104. When the drive bar 20 is released the drive bar moves back to the at rest position, causing a vacuum in the first liquid chamber 28, second liquid chamber 30 and the gas chamber 32 thus closing the valves 52 in the first and second liquid conduit 34, 36 and the gas conduit 38 and opening the valves 42, 46, 50 in the liquid inlets 40, 44 and the gas inlet 48 respectively. First and second liquids then flow into first and second liquid chamber 28, 30 and gas flows into the gas chamber 32. When equilibrium is reached the valves 42, 46, 50 will close. The dispenser is then ready to dispense the next shot of foam.

In summary the production of foam having particles suspended therein produced in accordance with the present invention consists of the steps of producing a first foam without particles, mixing the first foam with a liquid having particles suspended therein to produce a final foam having particles suspended therein.

It will be appreciated by those skilled in the art that figures are schematic representations of the invention herein. Specifically, the containers shown in these figures are generally not to scale. It will be appreciated that the containers could come in a variety of sizes. Further, the containers used herein may vary. Specifically inverted containers may be used. As well either collapsible or rigid containers may be used. FIG. 9 shows a dispenser 110 similar to that shown in FIG. 1 but with an inverted rigid container 112 with a hole 114 for the first liquid container and an inverted rigid container 116 with a hole 118 therein for the second liquid container. The nozzle 104 is similar to that described above in regard to FIGS. 7 and 8. The remainder of the features of dispenser 110 are as shown in FIG. 1.

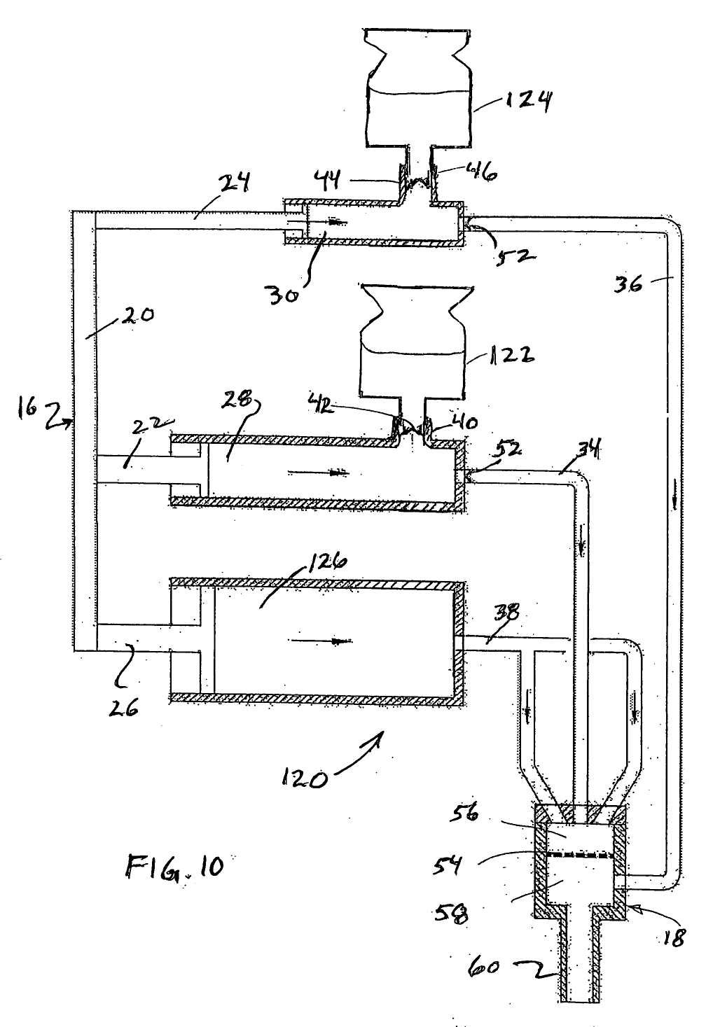

Another variation of the device is shown in FIG. 10 at 120. Device 120 is similar to that shown in FIG. 9 but with an inverted collapsible container as the first liquid container 122 and an inverted collapsible container 124 as the second liquid container. The gas chamber 126 is modified such that the nozzle 60 acts as the gas or air inlet for the device and therefore no valve is required in the gas conduit 38. The remainder of the features of dispenser 120 are as shown and described with regard to FIG. 1.

In use, as described above a person causes the drive bar 20 to move inwardly. This causes the first liquid piston 22, the second liquid piston 24 and the gas piston 26 to reduce the interior volume of the first liquid chamber 28, second liquid chamber 30 and the gas chamber 126 respectively. The increase in pressure caused by moving pistons 22 and 24 will open non-return valves 52 in the first liquid conduit 34 and second liquid conduit 36 respectively. Gas from the gas chamber 126 and liquid from the first liquid chamber 28 are pushed into the first mixing zone 56 where they are mixed. The gas and first liquid mixture is pushed through the porous member 54 to produce foam. Liquid from the second liquid chamber 30 is pushed into the second mixing zone 58 where it is mixed with the initial foam to produce the final foam which is dispensed through nozzle 60. When the drive bar 20 is released the drive bar moves back to the at rest position, causing a vacuum in the first liquid chamber 28, second liquid chamber 30 and the gas chamber 126 thus closing the valves 52 in the first and second liquid conduit 34, 36 and opening the valves 42 and 46 in the liquid inlets 40 and 44 respectively. First and second liquids then flow into first and second liquid chambers 28, 30. When equilibrium is reached the valves 42, 46 will close. Concurrently air is sucked into gas chamber 126 through nozzle 60 and gas conduits 38. By sucking air back through the nozzle 60 and gas conduits 38 a self cleaning feature is achieved. The dispenser is then ready to dispense the next shot of foam.

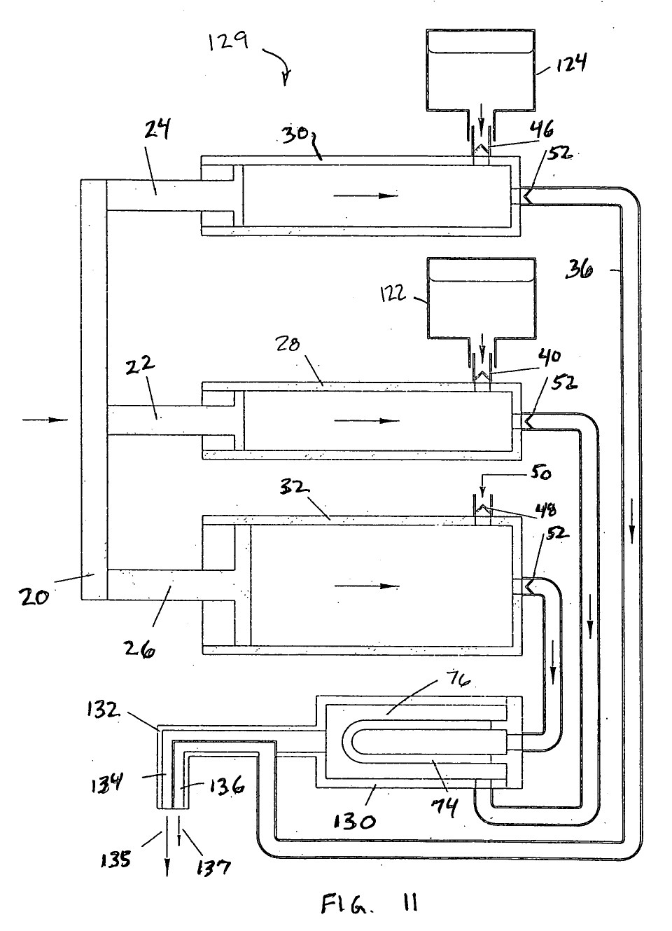

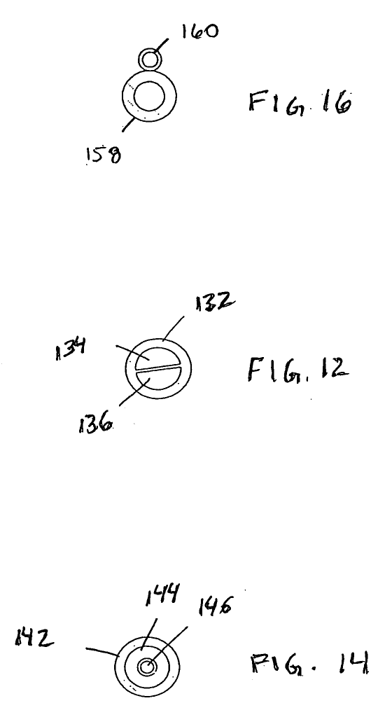

It will be appreciated by those skilled in the art that the second mixing zone may be down stream from the nozzle. Accordingly, three alternate foam dispensers are shown in FIGS. 11 and 12; 13 and 14; and 15 and 16 respectively. Specifically FIGS. 11 and 12 show a foam dispenser 129 similar to that shown in FIG. 9 but showing an inverted collapsible container as the first liquid container 122 and an inverted collapsible container 124 as the second liquid container foaming as shown in FIG. 10 and foaming component 130. Foaming component 130 is similar to that shown in FIG. 4 but the mixing of the first foam with the second liquid is down stream of the nozzle 132. Referring to FIGS. 11 and 12 foaming component 130 has an exit nozzle 132 that is partitioned into a foam portion 134 and a second liquid portion 136. The second liquid portion 136 is in flow communication with the second liquid conduit 36. The foam portion 134 is in flow communication with the first mixing zone 76. Accordingly two streams namely a first foam 135 and a second liquid 137 as shown with arrows are dispensed into the users hand and when the user rubs his/her hands together the two are mixed together providing a second mixing zone. The remainder of foaming component 130 is as described above with regard to foaming component 18. The remainder of the foam dispenser 129 is as described with regard to foam dispenser 110 shown in FIG. 9.

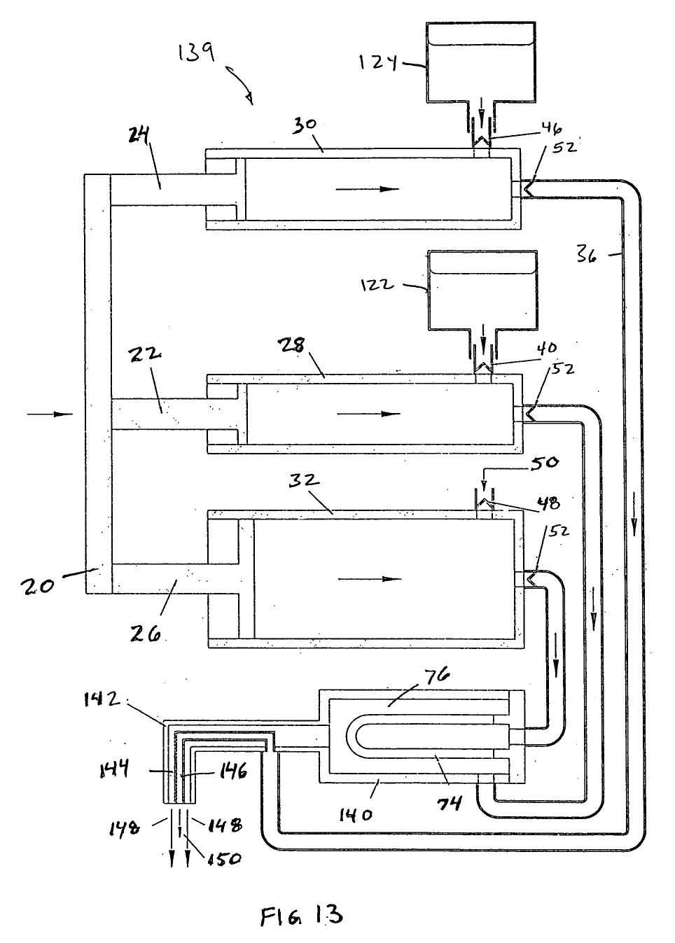

Referring to FIGS. 13 and 14, foam dispenser 139 includes a foaming component 140 which is similar to that shown in FIG. 4 but has a second mixing zone downstream of nozzle 142. Nozzle 142 is divided into a foam portion 144 and a second liquid portion 146. The foam portion 144 is an annular ring around the second liquid portion 146. The foam portion 144 is in flow communication with the first mixing zone 76 and the second liquid portion 146 is in flow communication with the second liquid conduit 36. The remainder of the foam dispenser 139 is as described above with regard to foam dispenser 110 shown in FIG. 9 but with the collapsible containers of dispenser 120 shown in FIG. 10. Similar to foaming component 130 the first foam is mixed with the second liquid downstream of nozzle 142. The first foam and the second liquid are dispensed concurrently as shown with arrows 148 and 150 respectively and a user would hardly notice that two different streams of material were being dispensed into their hand.

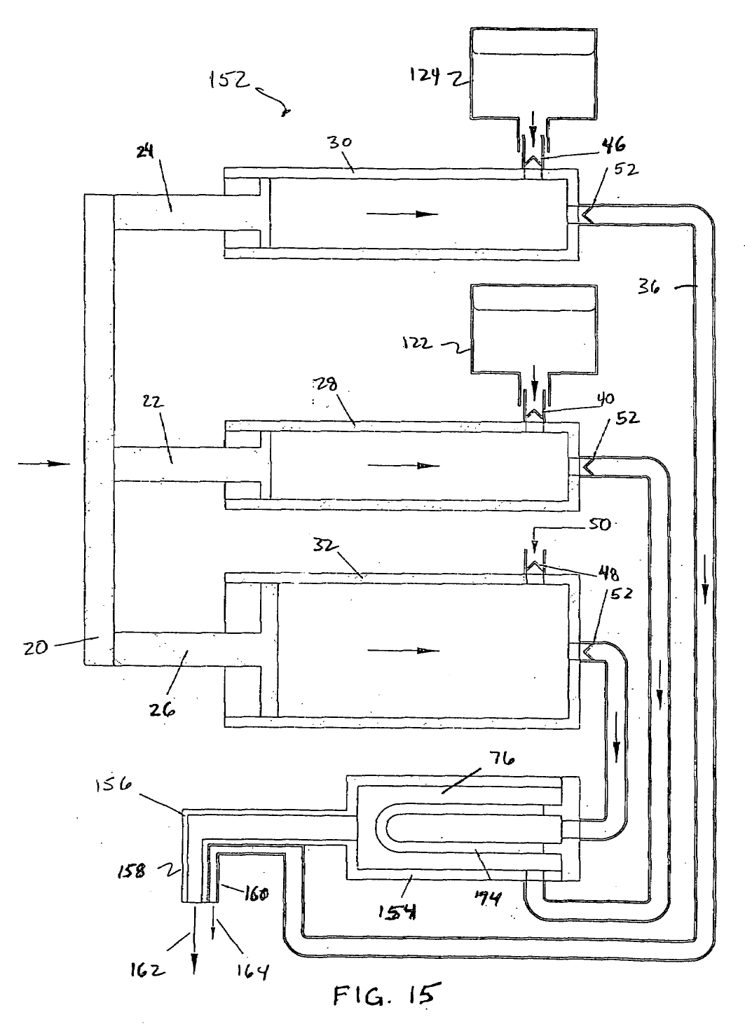

Referring to FIGS. 15 and 16, foam dispenser 152 includes a foaming component 154 which is similar to that shown in FIG. 4 but has a second mixing zone downstream of nozzle 156. Nozzle 156 is divided into a foam portion 158 and a second liquid portion 160. The foam portion 158 is a generally tubular conduit adjacent to the second liquid portion 160 which is also a generally tubular conduit. Foam portion 158 is in flow communication with the first mixing zone 76 and the second liquid portion 160 is flow communication with the liquid conduit 36. The remainder of the foam dispenser 152 is as described above with regard to foam dispenser 110 shown in FIG. 9 but with the collapsible containers of dispenser 120 shown in FIG. 10. Similar to foaming component 130 and 140, in foaming component 154 the first foam is mixed with the second liquid downstream of nozzle 156. The first foam and the second liquid are dispensed concurrently as shown with arrows 162 and 164 respectively and a user would hardly notice that two different streams of material were being dispensed into their hand.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A foam dispenser for dispensing foam from a first and a second liquid comprising:
a first liquid container for the first liquid;
a second liquid container for the second liquid;
a pumping mechanism for pumping the first liquid, the second liquid and gas;
a first foaming means for producing a first foam, the first foaming means being in flow communication with the first liquid container and a gas inlet and the first foaming means including a first mixing zone;
a second mixing zone in flow communication with the second liquid container and the first foaming means wherein the first foam is mixed with the second liquid to form a final foam.

2. A foam dispenser as claimed in claim 1 wherein the first mixing zone is a mixing chamber in flow communication with the first liquid and the gas inlet and wherein the first foaming means includes the mixing chamber and a porous member downstream of the mixing chamber whereby gas and the first liquid are mixed in the mixing chamber to form a mixture and the mixture is pushed through the porous member to form a first foam.

3. A foam dispenser as claimed in claim 2 wherein the second mixing zone includes a plurality of second liquid inlets each in flow communication with the second liquid container.

4. A foam dispenser as claimed in claim 2 wherein the second mixing zone includes a first and a second second liquid inlet on opposed sides of the second mixing zone and the second liquid inlet is downstream of the first liquid inlet and the first and second liquid inlets are in flow communication with the second liquid container.

5. A foam dispenser as claimed in claim 2 wherein the second mixing zone has an exit nozzle having a static mixing device therein.

6. A foam dispenser as claimed in claim 5 wherein the static mixing device includes a plurality of interleaved fingers therein.

7. A foam dispenser as claimed in claim, 2 wherein the first liquid container is collapsible and the second liquid container is collapsible.

8. A foam dispenser as claimed in claim 2 wherein the first liquid container is inverted and the second liquid container is inverted.

9. A foam dispenser as claimed in claim 2 wherein the first liquid container is rigid and the second liquid container is rigid.

10. A foam dispenser as claimed in claim 2 wherein the first liquid container is inverted and collapsible and the second liquid container is inverted and collapsible.

11. A foam dispenser as claimed in claim 2 wherein the pumping mechanism includes a first liquid piston housed in a first liquid chamber, a second liquid piston housed in a second liquid chamber and a gas piston housed in a gas chamber, the first liquid chamber is in flow communication with the first liquid container, the second liquid chamber is in flow communication with the second liquid container and the gas piston is in flow communication with the gas inlet, the first liquid piston, the second liquid piston and the gas piston are operably connected to a drive bar such that moving the drive bar moves the pistons in their respective chambers causing the first liquid, the second liquid and the gas to be drawn into the respective chambers.

12. A foam dispenser as claimed in claim 2 wherein the second liquid has particles suspended therein.

13. A foam dispenser as claimed in claim 1 wherein the means for producing a first foam includes a porous member having a gas chamber on one side thereof and the first mixing zone on the other side thereof, the gas chamber is in flow communication with the gas inlet, the first liquid container is in flow communication with the first mixing zone whereby the gas is pushed through the porous member and bubbles are formed in the first liquid to form a first foam.

14. A foam dispenser as claimed in claim 13 wherein the porous member is a porous mandrel and the porous mandrel defines the gas chamber.

15. A foam dispenser as claimed in claim 13 wherein the first liquid container is collapsible and the second liquid container is collapsible.

16. A foam dispenser as claimed in claim 13 wherein the first liquid container is inverted and the second liquid container is inverted.

17. A foam dispenser as claimed in claim 13 wherein the first liquid container is rigid and the second liquid container is rigid.

18. A foam dispenser as claimed in claim 13 wherein the pumping mechanism includes a first liquid piston housed in a first liquid chamber, a second liquid piston housed in a second liquid chamber and a gas piston housed in a gas chamber, the first liquid chamber is in flow communication with the first liquid container, the second liquid chamber is in flow communication with the second liquid container and the gas piston is in flow communication with the gas inlet, the first liquid piston, the second liquid piston and the gas piston and operably connected to a drive bar such that moving the drive bar moves the pistons in their respective chambers causing the first liquid, the second liquid and the gas to be drawn into the respective chambers.

19. A foam dispenser as claimed in claim 13 further including a plurality of second liquid inlets each in flow communication with the first liquid container.

20. A foam dispenser as claimed in claim 13 further including a first and a second second liquid inlet on opposed sides of the second mixing zone and the second inlet is downstream of the first inlet.

21. A foam dispenser as claimed in claim 13 wherein the second mixing zone has an exit nozzle having a static mixing device therein.

22. A foam dispenser as claimed in claim 21 wherein the static mixing device includes a plurality of interleaved fingers therein.

23. A foam dispenser as claimed in claim 13 wherein the second liquid has particles suspended therein.

24. A foam dispenser as claimed in claim 1 wherein the gas is air.

25. A foam dispenser as claimed in claim 2 wherein the gas is air and the gas inlet is a nozzle.

26. A foam dispenser as claimed in claim 1 further including and exit nozzle and wherein the second mixing zone is downstream of the exit nozzle.

27. A foam dispenser as claimed in claim 26 wherein the exit nozzle has a foam portion and a second liquid portion and the foam portion is in flow communication with the first mixing zone and the second liquid portion is in flow communication with the second liquid container.

28. A foam dispenser as claimed in claim 27 wherein the foam portion and the second liquid portion are concentric.

29. A foam dispenser as claimed in claim 27 wherein exit nozzle is divided in half into the foam portion and the second liquid portion.

30. A method of producing a final foam comprising the steps of:
producing a first foam from a first liquid and gas;
mixing a second liquid with the first foam to form a final foam.

31. A method as claimed in claim 30 wherein the second liquid has particles suspended therein and the final foam has particles therein.

32. A method as claimed in claim 31 wherein the particles are chosen from a group consisting of pumice, cornmeal, ground walnut shells, ground fruit stones, microbeads, microcapsules, dried pulses and a combination thereof.

33. A method as claimed in claim 30 wherein the gas is air.

34. A method as claimed in claim 30 wherein the first and second liquids are unstable when mixed together.
